(19) United States
(12) Patent Application Publication
(10) Pub. No.: US 2005/0025868 A1
(43) Pub. Date: Feb. 3, 2005

(54) Method of removing pericarp from grain in recoverable form

(76) Inventors: Daniel W. Karl, St. Paul, MN (US); Sandra L. Brovold, Saint Paul, MN (US)

Correspondence Address: GRAY, PLANT, MOOTY, MOOTY & BENNETT, P.A., P.O. BOX 2906, MINNEAPOLIS, MN, 55402-0906, US

(21) Appl. No.: 10/877,451

(22) Filed: Jun. 25, 2004

Related U.S. Application Data
(60) Provisional application No. 60/482,894, filed on Jun. 25, 2003.

(51) Int. Cl. A23P 1/00

(52) U.S. Cl. 426/481

(57) ABSTRACT

A method for debranning grain, such as corn, involves treating the grain with hot water, followed by (1) treating the grain with an aqueous solution of a strong base and (2) detaching pericarp from the grain. Ethanol may be produced by hydrolyzing debranned grain produced by this method to sugars, and fermenting the sugars to ethanol. Alternatively, chemically or enzymatically modifying grain involves treating the grain with water to create a permeability barrier in the endosperm of the grain, and chemically or enzymatically modifying the portion of the grain outside the permeability barrier.

CROSS-REFERENCE TO RELATED APPLICATION

This application claims the benefit of provisional application number 60/482,894 filed Jun. 25, 2003.

### BACKGROUND

Cereal grains, such as corn, contain a tough outer layer called the pericarp that is primarily composed of fiber. Inside the pericarp is the starchy endosperm and the germ, which is comparatively rich in protein and oil. The endosperm includes an outer nutrient-rich aleurone layer. Some grains such as wheat and most barleys have in addition to the pericarp an outer layer known as the hull. In corn milling the bran fraction commonly includes the pericarp and aleurone, while for other grains the bran fraction can include the hull as well. Bran fractions are commonly used as animal feeds, but also find use as chemical and biochemical feedstocks for products including furfural, xylitol, and industrial enzymes. Since the pericarp contains the major fraction of the bran or fiber in grains, grains from which the pericarp specifically, or fiber generally, has been removed are known as “debranned” grains.

Processing of grains to flour, corn starch, or other food products, as well as to ethanol or other industrial products requires penetrating or breaking the pericarp. This is often done by mechanical means. However, mechanical rupture of the pericarp leaves endosperm attached to the pericarp, making it difficult to separate fiber from starch. The attachment of pericarp fragments to endosperm also keeps the endosperm in larger fragments with less surface area than could otherwise be attained, which increases processing time and costs.

Alkali pretreatment of corn has been reported to loosen and separate the pericarp or dissolve the pericarp (Blessin, C. W., et al., Chemical Dehulling of Dent Corn, Cereal Chem. 47:303 (1970)). Alkali treatment facilitates isolation of the pericarp from the endosperm. However, relatively large amounts of base are used, which adds to the cost of the processing. Large volumes of water also are used, which can add to the cost of downstream processing or waste removal. Even when the alkaline treatment is conducted in such a manner as to loosen or detach the pericarp rather than dissolve it outright, substantial carbohydrate and other materials are solubilized. If the material solubilized from the pericarp is too dilute it is difficult to recover it for beneficial use. If the solubilized material is not recovered, it generally must be subjected to waste treatment operations due to its high biological oxygen demand (BOD). Another drawback to these methods is that the base generally penetrates the endosperm. This phenomenon can be detrimental to further processing of the endosperm. For instance, to neutralize the base in the endosperm, it is sometimes necessary to add acid, which adds cost to the process. Furthermore, along with base penetration, water penetration occurs. This can be deleterious because it is desirable in many applications to limit the amount of water absorbed by the endosperm, for instance to retain adequate hardness for further mechanical processing or to limit the energy required to dry the material.

New methods to loosen, remove, or isolate the pericarp or to isolate fiber from grains are needed. Preferably these methods will reduce the amount and cost of chemicals used. Preferably the methods will facilitate isolation of the pericarp or fiber in high yield as a separate fraction. Preferably the solubilized material will be readily recoverable. Preferably the methods will minimize the loss or alteration of endosperm or aleurone as compared to current methods.

Techniques to control the entry of water and prevent or lessen penetration or modification of endosperm by acid, base, or other chemical agents used to debran grain or otherwise modify or treat grain are also needed. It is known that seeds of grasses, including cereal grains, have an endogenous selective permeability barrier, which prevents or restricts entry of certain materials into the endosperm. For instance, this barrier prevents the entry of strong acids into the endosperm, and directs water entering the pericarp of a corn grain at the tip cap around the grain so that most of the water enters the endosperm at the opposite end of the kernel. This barrier appears to be associated with the aleurone. It is not an absolute barrier, as iodine and some other small hydrophobic molecules appear to cross it freely, and water crosses slowly. This barrier is known to be destroyed by base treatment so that it is not active under conditions commonly employed in alkaline debranning. There is also a permeability barrier associated with the outside of the pericarp that is easily disrupted by abrasion, hot water, or base. A permeability barrier resistant to base located below the aleurone and capable of restricting entry of both hydrophobic and hydrophilic solutes would overcome several limitations of the endogenous barriers. It could also be used in conjunction with them to permit selective modification of aleurone structures.

### SUMMARY OF THE INVENTION

The invention is a method of debranning grain that involves sequentially treating the grain first with hot water, and then with an aqueous solution of a strong base. In certain embodiments, the method has the advantages of reducing the amount of base used and reducing the amount of water used compared with previous methods of alkaline debranning of corn. In certain embodiments of the method, the debranned grain absorbs less base than in previous methods, and therefore it is not necessary to neutralize the pH of the debranned grain with an acid. It is believed that the hot water treatment creates a permeability barrier in the outer layers of the endosperm of the grain that prevents or lessens penetration of the endosperm by base in the step of treating the grain with an aqueous solution of a strong base. This results in decreased consumption of the base, and in more effective action of an equivalent amount of the base against the pericarp when the grain is subsequently treated with an aqueous solution of a strong base.

This debranning process provides reduced loss and chemical alteration of the endosperm and aleurone layers compared to prior methods. It also provides good isolation of the pericarp or fiber in high yield as a separate fraction, with less contamination by starch or endosperm. The method also uses lower amounts of water than prior methods.

The debranned grain can be further processed in various ways. For instance, it can be processed to isolate germ, or starch or protein, or it can be processed to make flour or corn starch, or converted to ethanol.

While it is believed that the results of the invention can be achieved though use of room temperature water and a different mechanism for creating a permeability barrier, a preferred embodiment of the invention is a method of creating a permeability barrier in grain by treating the grain with hot water. By treating the grain with hot water, i.e., above about 60° C., the grain develops a permeability barrier. The permeability barrier can be recognized by staining the grain with a dye such as methylene blue and observing even staining of the pericarp and no staining of the remainder of the endosperm or staining of only the surface of the endosperm. That is, the stain does not penetrate into the interior of the endosperm, even at the dent and in the region of the tip cap where the endogenous permeability barrier permits some entry of the dye. The presence of the permeability barrier can alternatively be recognized by exclusion of the dye persisting after alkaline treatment. The grain containing the permeability barrier is useful as an intermediate in subsequent processes. For instance, the grain containing a permeability barrier can be further processed by alkaline debranning (debranning by the action of base), as described herein. It can also be subjected to other chemical reactions such as etherification, oxidation, reduction, or dye coupling to provide a convenient in-situ modification of pericarp cell wall components to alter their properties, to establish their location, or to facilitate their isolation, and so could be useful in cell wall research as well as grain processing.

Creation of the permeability barrier facilitates subsequent treatment of the pericarp or other outer layers of the grain, such as the aleurone, or components thereof, with lessened modification or loss of the endosperm. The method also facilitates isolation of the bran, or components thereof such as pericarp, or other layers of the grain, such as the aleurone, with reduced contamination and with reduced loss of endosperm.

One embodiment of the invention provides a method for debranning grain comprising: (1) treating the grain with hot water; followed by (2) treating the grain with an aqueous solution of a strong base; and (3) detaching the pericarp from the grain to yield debranned grain.

Another embodiment of the invention provides a method of chemically or enzymatically modifying a grain comprising: treating the grain with hot water so as to create a permeability barrier in the endosperm of the grain, thereby creating a portion of the grain outside the permeability barrier and a portion of the grain inside the permeability barrier; and chemically or enzymatically modifying the portion of the grain outside the permeability barrier, preferably without chemically or enzymatically modifying the portion of the grain inside the permeability barrier.

Another embodiment of the invention provides a method of producing ethanol from grain comprising: (1) treating the grain with hot water; followed by (2) treating the grain with an aqueous solution of a strong base; and (3) detaching the pericarp from the grain to yield debranned grain; then hydrolyzing the debranned grain to sugars; and fermenting the sugars to ethanol.

### DETAILED DESCRIPTION

Definitions

“Treating grain with hot water” means contacting grain with liquid water or steam having a temperature above about 60° C. The water may contain solutes, including, for instance, salts, weak acids, weak bases, small amounts of strong acids or strong bases, and water-miscible solvents such as ethanol. The solutes preferably do not unduly disrupt the structure of the grain or the native permeability barrier of the grain. Thus, the rate of penetration of water into the grain will remain slow, i.e., slower than the rate of moisture uptake upon incubation of comparable grain with a hot solution of strong base. In the step of treating the grain with water, the pH of the water is lower than the pH of the aqueous solution of a strong base used in the step of treating the grain with an aqueous solution of a strong base. In both the method of debranning grain and the method of chemically or enzymatically modifying a grain, the pH of the water is between 2 and 11 inclusive, preferably between about 4 and about 10 inclusive, or more preferably between about 5 and about 8 inclusive. Preferably the solutes in the water are less than 30%, and more preferably less than 10%, of the weight of the water.

“Treating grain with an aqueous solution of a strong base” means contacting grain with a liquid solution containing water and a strong base, with or without added steam. A strong base is a compound that in water under the conditions of use is substantially fully ionized to at least one hydroxide ion and at least one cation. The aqueous solution of a strong base may contain supplementary amounts of a weaker base or of other solutes. The aqueous solution of a strong base has an initial pH higher than 12, and preferably about 13 or higher. The aqueous solution of a strong base may contain solutes or cosolvents including but not limited to alcohols, neutral salts, surfactants, glycols, and other materials that do not react with the base or the grain. These may be present incidentally or be added to achieve an effect such as raising the boiling point of the mixture, but otherwise are not necessary. They may be tolerated provided they do not react with other ingredients of the process, or generate undesirable byproducts, adversely affect the rate or other performance of the process, etc.

“Detaching the pericarp” means removing the pericarp from the grain, or at least creating a physical separation between the pericarp and the underlying layers over at least about 50% of the surface area of the grain. The detached pericarp may remain partially attached to the grain, e.g., at one point or over an area of the grain of less than 50% of the surface area of the grain. More preferably, in detaching the pericarp, the pericarp is physically separated from the underlying layers of the grain over at least about 60% of the surface area of the grain, more preferably at least about 80% of the surface area of the grain, and even more preferably at least about 90% of the surface area of the grain. The term “detaching the pericarp” also encompasses completely releasing the pericarp from the grain or dissolving the pericarp. In general, part of the pericarp will be dissolved and the remainder will persist as discrete particles.

“Starting weight” of the grain refers to the weight prior to treating the grain with hot water or steam.

“Debranned grain” refers to grain from which the pericarp has been detached, as defined above.

“Releasing the pericarp” refers to achieving a complete physical separation of fragments of pericarp, or of an intact pericarp, from a grain kernel, so that the fragments of pericarp or intact pericarp have no point of attachment to the grain and can move freely from the grain. The term “releasing the pericarp” also encompasses dissolving the pericarp. Preferably, the released pericarp is at least 60%, more preferably at least 80%, of the total pericarp in the grain.

“Separating released pericarp from the debranned grain” refers to isolating debranned grain or released pericarp from a mixture containing both. Separating released pericarp from debranned grain includes removing a solution containing dissolved pericarp from debranned grain.

“Mole equivalents” of base or acid refers to the number of moles of protons the acid can release or the base can take up, or the number of moles of hydroxide ions the base can release. Thus, for instance, 1 mole of hydrochloric acid is 1 mole equivalent of acid, while 1 mole of sulfuric acid is two mole equivalents of acid.

Description

In the method of chemically or enzymatically modifying a grain involving creating a permeability barrier in endosperm of the grain, the permeability barrier can be recognized by staining the grain with methylene blue and observing even staining of the pericarp if it is present, and no staining of the endosperm, or staining of the aleurone layer (which is located at the surface of the endosperm and is considered part of the endosperm) or the surface of the endosperm (i.e., staining showing a visually sharp demarcation between the stained region and unstained endosperm and penetrating to a depth of about 5% or less of the thickness of the endosperm) with methylene blue, but no staining of the interior of the endosperm. The staining of the aleurone or the surface of the endosperm can result in, for instance, a green or blue color.

Without wishing to be bound by theory, it appears that the secondary permeability barrier is established at least in part by altering the state of polymeric constituents of the grain, possibly including but not necessarily limited to starch. Since it is well known that the thermal transitions of polymers are highly sensitive to the composition of the solvent present, it can be anticipated by one skilled in the art that the amount of moisture present and the presence of solutes or co-solvents may alter the temperature required to establish the permeability barrier without fundamentally altering the nature of the barrier or of the process. Such changes of required temperature with composition of the aqueous phase are considered to be included in the specification even when not specifically pointed out.

In one embodiment of the method of chemically or enzymatically modifying a grain, the grain is treated with water at a temperature of at least about 55° C. to create a permeability barrier. In other embodiments, the grain is treated with water at a temperature of at least about 75° C., at least about 85° C., at least about 90° C., about 90° C. to about 105° C., about 99° C. to about 105° C., or about 95° C. to about 100° C. The water can be in the form of steam, or the grain can be treated with liquid water under pressure at above 100° C.

In one embodiment of the method of chemically or enzymatically modifying a grain, the grain is treated with the water for about four minutes to create a permeability barrier. In other embodiments, the grain is treated with water so as to create a permeability barrier for a time between about one minute and about thirty minutes; between about one minute and about fifteen minutes; for a time chosen to provide a desired moisture content of the grain greater than the initial moisture content; or for a time chosen to provide essentially complete absorption of a given amount of water.

In one embodiment, the grain is corn. In other embodiments, the grain is wheat, rice, oats, barley, sorghum, or other cereal grain. In still other embodiments, the grain is barley, including hulless barley.

In one embodiment of the method for debranning grain, the step of treating the grain with an aqueous solution of a strong base detaches the pericarp.

In another embodiment, the detaching step involves adding water to the grain to form a grain-water mixture and agitating the grain-water mixture to detach the pericarp from the grain. Prior to the adding of the water, the grain may absorb substantially all of the aqueous solution of strong base, or the grain may be separated from the aqueous solution of the strong base. Alternatively, the grain may absorb only a portion of the aqueous solution of the strong base, in which case the added water dilutes the remaining portion of the strong base, and the grain-water mixture to be agitated contains some of the aqueous solution of strong base. Agitating the grain water mixture may also be used to release the detached pericarp from the grain.

In particular embodiments, the detaching step or the releasing step involves adding water and an abrasive such as sand, calcium carbonate, polypropylene shavings, ground corn cobs, iron filings, or alumina, to form a grain-water-abrasive mixture, and agitating the mixture to detach or release the pericarp from the grain.

In one embodiment of the method for debranning grain, the method involves releasing the pericarp from the debranned grain.

In a particular embodiment, pericarp is released from the grain in the step of treating the grain with an aqueous solution of a strong base. In another particular embodiment, the releasing step involves adding water to the grain to form a grain-water mixture and agitating the grain-water mixture to release the pericarp from the debranned grain, as described above for detaching the pericarp.

In a particular embodiment, the method further involves separating the released pericarp from the debranned grain. The separating can be accomplished, for example, by contacting the mixture of debranned grain and released pericarp with a screen to separate the released pericarp from the debranned grain or by other methods known to those skilled in the art (e.g., by density flotation).

In a particular embodiment of the method of debranning grain, released pericarp is separated from debranned grain after drying by aspiration.

In particular embodiments of the method of debranning grain or the method of chemically modifying grain, prior to treating the grain with water, the grain has a moisture content of less than about 35% by weight, less than about 25% by weight, or less than about 20% by weight. In a particular embodiment, the grain has a moisture content of about 14-18% by weight. In other embodiments, the moisture content prior to treatment with water may be about 5% to about 35% by weight. In general, the grain should not be extensively stress cracked, nor should it be too soft to remain intact in mechanized handling. Neither should the water content of the starting grain be so high that the endosperm starch as a whole begins to paste or gelatinize at the temperature of the reaction. For the latter reason, material to be treated at about 80° C. should typically be restricted to a maximum of about 30% starting moisture. Material to be processed at about 90° C. should generally be restricted to a maximum of about 26% starting moisture; material to be processed at about 100° C. should generally be restricted to a maximum of about 23% starting moisture; and material to be processed at about 110° C. should generally be restricted to a maximum of about 19% starting moisture.

In a particular embodiment, the amount of the water or steam in the step of treating the grain with water is about 20% of the starting weight of the grain. In other particular embodiments, the amount of water or steam absorbed by the grain may be between about 2% and about 30% of the starting weight of the grain. Any excess water may be drained and, if desired, recycled. Generally, less water will be used with higher-moisture grain. The amount will vary somewhat with the method of application of the water, the method and rate of heating, the method of mixing, and the desired water treatment temperature. In systems relying on mechanical mixing for distributing the water and ensuring uniform heating, the minimum amount of water required is that which is just sufficient to keep the surface of the grain moist and lubricated as the grain is heated to the desired temperature. In systems employing excess water as the mixing and heat transfer medium, for instance aqueous fluidized beds or stirred tanks, the water temperature and level are controlled by the temperature and residence time. In systems involving steam heating, it is desirable that either the grain is uniformly pre-wetted with a small amount of water, or else that the incoming grain is cooler than the steam by an amount chosen to condense the requisite amount of water onto the corn.

In other particular embodiments, the amount of water in the step of treating the grain with water is 5% to 30% or 7% to 25% of the starting weight of the grain.

In a particular embodiment, the hot water treatment is conducted by contacting the grain with steam under conditions where part of the steam condenses on or in the pericarp and the process is controlled solely according to the temperature attained by the grain. That temperature is preferably at least 70° C. and more preferably at least 80° C.

In a particular embodiment, the grain temperature during the step of treating with hot water increases to a temperature in the range of from 85° C. to 103° C. In other embodiments, this temperature may be fixed or vary within the range of about 75° C. to about 125° C.

In other particular embodiments, the treating the grain with water is at a temperature of at least about 55° C., at least about 75° C., at least about 85° C., at least about 90° C., about 90° C. to about 105° C., about 99° C. to about 105° C., or about 95° C. to about 100° C. The water can be in the form of steam, or the grain can be treated with liquid water under pressure at above 100° C.

In a particular embodiment, the grain is treated with hot water for a time of about 12 minutes. In other embodiments, the grain is treated with water for a time as short as 1 minute at 100° C., or even shorter in steam, to as long as 60 minutes. In general, the required time will be shorter at higher temperature and water uptake will continue slowly during the step of treating with water, so that the maximum time will be set by the allowable water uptake. The minimum time may be set by the requirement to achieve reasonably uniform distribution and penetration of water and heat, which time may be longer in larger-scale implementations. In particular embodiments, the step of treating the grain with water is for a time between about one minute and about thirty minutes; or between about five seconds and about sixty minutes; or up to about sixty minutes.

In a particular embodiment of the method of debranning grain, the temperature of the grain reaches a temperature of from 99 to 108° C. during treatment of the grain with an aqueous solution of a strong base. In particular embodiments, the temperature of the mixture of the grain and the aqueous solution during this treatment is at least about 60° C.; or at least about 85° C.; or between about 85° C. and about the boiling point of the aqueous solution; or between about 90° C. and about the boiling point of the aqueous solution; or between about 90° C. and about 100° C.; or between about 90° C. and about 110° C. In a particular embodiment, the temperature of the mixture during this treatment is about 110° C. In general, up to about 100° C., the amount of pericarp detached or released per unit of strong base increases strongly with temperature. Above 100° C., the same trend continues but not as strongly.

In a particular embodiment, the step of treating the grain with an aqueous solution of a strong base is for a time of about six minutes. In other embodiments, the time is between about ten seconds and about sixty minutes; or up to about sixty minutes; or between about one minute and about thirty minutes; or between about two minutes and about thirty minutes. The short time limit may be set by the necessity of obtaining reasonably uniform distribution of base and heat.

The strong base is preferably a monovalent alkali metal hydroxide. Other bases such as tetraalkylammonium hydroxides can also be used. Some divalent alkaline earth metal oxides or hydroxides may be also be used; one example is lime, although the efficiency of the process will be reduced. Mixtures of bases, including mixtures of alkali metal hydroxides with supplemental alkaline earth hydroxide, ammonia, alkali metal carbonate, or other strong or semi-strong base can also be used. In general, any base that has been found effective in conventional alkaline debranning (i.e., alkaline debranning carried out without prior water treatment to create a permeability barrier) can be used effectively and in decreased amount compared with the conventional procedure using that base. In particular embodiments, the strong base is sodium hydroxide or potassium hydroxide. In less preferred embodiments, the strong base could be sodium carbonate or potassium carbonate. In particular embodiments, the conjugate acid of the strong base has a pKa of at least about 12 or at least about 13.

The aqueous solution of a strong base has an initial pH (prior to contact or reaction with the grain) higher than about 12, or more preferably about 13 or higher. It is believed that the aqueous solution of a strong base could have an initial pH as low as 11.5, but the resulting process would not be expected to have a high enough yield rate to be commercially practical or preferred. The concentration of strong base in the aqueous solution is preferably at least 50 mM. In particular embodiments, the concentration of strong base is at least about 100 mM, at least about 200 mM, at least about 0.5 M, about 50 mM to about 1 M, or about 50 mM to about 2 M.

In a particular embodiment where the grain is treated with an aqueous solution of sodium hydroxide, the amount of sodium hydroxide in the aqueous solution is an amount between about 2 and about 6 grams per kilogram of grain, preferably an amount between about 4 and about 5 grams per kilogram of grain. In a more specific embodiment, the grain is corn.

In a particular embodiment, the aqueous solution of strong base contains less than about 0.5 mole equivalents of base per kg of grain. In another particular embodiment, it contains less than about 0.2 mole equivalents of base per kg of grain. In other particular embodiments, the aqueous solution of strong base contains less than 1, less than 0.8, less than 0.7, less than 0.6, less than 0.4, or less than 0.3 mole equivalents of base per kg of grain. In the case of hydroxides, less than 0.15 mole equivalents of base per kg of grain is known to be suitable.

It will be appreciated by those skilled in the art that in many cases it is preferable to minimize the amount of base used, both to minimize its cost and to minimize its impact on subsequent process steps. In such cases, it is advantageous to use the minimum volume of aqueous solution of strong base consistent with uniform mixing and sufficient to keep the surface of the corn or other grain moist through the reaction time, with the base concentration chosen to ensure sufficient total base. Under these conditions, the base is consumed quickly by reaction with components of the pericarp, as shown by a sharp drop in pH. In general, when alkali metal or quaternary ammonium hydroxides are used to debran commercial varieties of corn (lines widely grown in the U.S.) at temperatures greater than 95° C., the amount of base required is 0.1 to 0.2 moles per kg corn, for instance 4 to 8 g sodium hydroxide per kg corn. In particular experiments, 4.3 to 5.8 g sodium hydroxide per kg corn were used, varying somewhat within the range for different lots of corn. This approach usually leads to using a base concentration of about 0.5-2.5 moles/liter, but the ratio of base to grain is more important than the concentration of base.

It will also be appreciated by one skilled in the art that a high initial concentration of base will be associated with a rapid reaction rate. An advantage of the method of the invention over other alkaline debranning methods is that establishment of the permeability barrier permits use of a small amount of concentrated base to accomplish the debranning. By limiting penetration of base into the interior of the kernel, the permeability barrier limits overall base consumption while directing the base to the desired sites of reaction in and adjacent to the pericarp. Thus, base concentration is preferably at least 50 mM, more preferably at least 250 mM, and still more preferably at least 500 mM.

Without wishing to be bound by theory, it believed that the permeability barrier is not absolute, and that water continues to enter the kernel. It is also believed that the decreased penetration of the base into the endosperm, and consequently the efficient utilization of a limited amount of base, is related in part to rapid reaction of the base with sites within or adjacent to the pericarp; this reaction competes effectively with restricted migration into the endosperm due to the presence of the permeability barrier. Thus, base is efficiently used when conditions favor rapid reaction rates.

Conventional wet mill operations for corn processing are commonly restricted to temperatures less than 55-58° C. to avoid starch pasting and retrogradation. It is well known that starch pasting is restricted in environments of limited water content, so it will be appreciated by those skilled in the art that the low water content of the corn during the debranning permits operation at higher temperature without gross pasting. It is perhaps surprising, however, that the starch is not more altered by the treatment. Thermal treatment of starch at limited water content is used to make amylase-resistant starch. In the case of corn debranned by this process, subsequent grinding of the corn, isolation of the germ, and alpha-amylase digestion of the starch have been accomplished successfully; the amylase digestion proceeds to completion as judged by iodine color. The yield of oligosaccharides and of ethanol in subsequent fermentation is comparable to conventionally-processed corn, with no evidence of any altered starch or unusually resistant material. The advantage of the higher temperature operation, as opposed to conventional alkaline debranning and lower temperature variants of this method, is that the reaction is faster and the utilization of base is more efficient.

There is a wide variation in genotypes of corn, so that varieties may be encountered with unusually thick or resistant pericarps. For instance, such a variety might have been bred for insect resistance. In general, incomplete debranning associated with a particular batch or line of corn can be remedied by using a higher ratio of base to corn.

In a particular embodiment of the method of debranning grain, the moisture content of the debranned grain is 35% to 50% by weight.

In a particular embodiment of the method of debranning grain, more than about 80% of the water is absorbed by the grain in the step of treating the grain with water.

In a particular embodiment, in the step of treating the grain with an aqueous solution of a strong base, more than about 80% of the water in an aqueous solution of a strong base is absorbed by the grain, while the base is consumed by reactions largely in the pericarp.

In a particular embodiment of the method of debranning grain, following treating the grain with water, the aqueous solution of a strong base is formed by adding a strong base to the water.

In a particular embodiment, the pH of endosperm of the grain is not substantially increased by the aqueous solution of a strong base. This can be evidenced, for instance, by lack of change in the staining properties of the endosperm when the debranned grain is rinsed, cut in two with a razor bade, and stained with phenol red or other suitable dye. Alternatively, lack of change of pH of the endosperm can be evidenced by grinding rinsed debranned grain in a blender and measuring the pH of the homogenate. In each case, the lack of change is as compared to a parallel batch of grain treated with water, but not with the aqueous solution of strong base.

In a particular embodiment using sodium hydroxide as the base, the sodium content of the debranned grain after rinsing is not appreciably increased by the treatment.

In a particular embodiment, the corn can be debranned at temperatures of 103-108° C., reaching a moisture content of 40% to 50% by weight, ground after debranning and digested with alpha-amylase to give a negative iodine test, indicative of substantially complete conversion of the starch to glucose.

In a particular embodiment of the method of chemically or enzymatically modifying the grain, the method involves chemically modifying the portion of the grain outside the permeability barrier by treating the grain with acid. In another embodiment, the method involves chemically modifying the portion of the grain outside the permeability barrier by treating the grain with base. In another embodiment of the method of chemically or enzymatically modifying a grain, the method involves enzymatically modifying the portion of the grain outside the permeability barrier. The enzymatic modification can, for instance, involve treating the grain with a hydrolytic enzyme.

In the method of producing ethanol from grain, the debranned grain can be hydrolyzed to sugars and the sugars fermented to ethanol by techniques known in the art, such as those disclosed in U.S. Pat. No. 4,810,647; or in S. M. Lewis, “Fermentation Alcohol,” in Industrial Enzymology, 2nd edition, Godfrey, T., and S. West editors.

The invention will now be further illustrated with the following non-limiting examples.

### EXAMPLES

### Example 1.

### Establishment of a Permeability Barrier

Methods

Method A. This method is from Mistry and Eckhoff (Cereal Chem. 69:82-84 (1992)). 100 g corn was soaked in 200 ml of a 6% NaOH solution in water (w/v) at 57° C. for 8 minutes.

Method B. Corn was submerged in water and boiled for periods of time ranging from 5 to 30 minutes.

Staining of Corn. Whole corn grains were stained in 1% aqueous methylene blue for 5-10 minutes and then examined under a binocular dissecting microscope. Grains were cut in two with a razor blade to examine the extent of dye penetration.

Pericarp removal. Corn grains were tested for pericarp adhesion and softening of the grain by first rubbing them gently between rubber-gloved fingers, and then rubbing more vigorously. If the pericarp split but did not come off, it was tested further by pulling with forceps.

Results

Intact untreated corn showed little staining with methylene blue except near the tip cap dent and any cracks in the pericarp. Some stain in untreated corn migrated into the endosperm near the dent and tip cap, similar to known pathways of water entry.

When corn was treated by Method A, good removal of the pericarp was seen. Blue stain penetrated into the endosperm, staining the endosperm and germ.

The boiling water treatments resulted in staining the pericarp an even, deep blue. The outer surface of the aleurone layer stained green. In some samples of boiled corn a refractive line was visible in the endosperm, just under the aleurone layer. Stain did not penetrate beneath this portion. The boiling water treatments swelled the pericarp, but did not remove it. The longer boiling water treatments made it somewhat easier to remove the pericarp with forceps.

Conclusions

The Mistry and Eckhoff procedure of heating dry corn in sodium hydroxide solution resulted in penetration of dye into the endosperm, and thus most likely in penetration of base and water into the endosperm. Boiling the dry corn in water without base softened the pericarp and eliminated the outer permeability barrier that prevented penetration of dye into the pericarp and aleurone layers of untreated corn. However, it appeared to establish another permeability barrier at the outer portion of the endosperm that prevented penetration of dye into the endosperm. This permeability barrier is believed to be composed of gelatinized starch.

### Example 2

### Comparison of Boiling in Water and Soaking in Water at Room Temperature

Methods

Corn (100 g) was boiled for 15 minutes in 80 ml water or soaked for 15 mm in 80 ml water at room temperature. Then moisture content was measured and the corn was stained with methylene blue and dissected as in Example 1. Moisture content was determined as the ratio of weight after water treatment minus weight before treatment, to the weight before treatment.

Results

The boiled samples gained 350-360 mg moisture content per g starting weight of corn over the starting moisture content. The samples soaked at room temperature gained 100-140 mg moisture content per g starting weight of corn. In both samples, the pericarp stained blue with no migration of the stain into the endosperm.

Interpretation

The boiled sample gained more water than the room temperature sample. This may suggest that the permeability barrier induced by hot water is not absolute, or that substantial water entered the grain before the barrier was established.

### Example 3

### Effect of Concentration of Base

Methods

Fifty grams of corn was boiled with 50 ml of water for 15 or 30 minutes, and then in a second step mixed with 30 ml of 1%, 2%, 3% or 6% NaOH and steeped without further heating for 15 minutes. The base was then poured off and the corn was inspected for the ease or difficulty of removing the pericarp.

Results

After the base treatment, there was no difference in the ease of removing the pericarp between samples boiled for 15 minutes in water prior to the base treatment, and samples boiled for 30 minutes in water prior to the base treatment. In the samples treated with 1% NaOH, the pericarp was removable only with heavy pressure. In the samples treated with 2% or 3% NaOH, the pericarp was removable with slight pressure. In the samples treated with 6% NaOH, the pericarp was removable with agitation and washing.

### Example 4

### Alkaline Debranning Method Comparison

Methods

(a) Single-step method. 100 grams corn was soaked in 200 ml of 6% NaOH in water for 8 minutes at 57° C. Corn was then rinsed with water and placed in a plastic bag for abrading. Corn was abraded by rubbing the corn in the bag, producing kernel-on-kernel abrasion. Corn was then washed over a #40 mesh screen to separate the removed pericarp, which was collected over a #120 mesh screen. (Mistry and Eckhoff, Cereal Chem. 69:82-84 (1992)).

(b) Two-step bench top method. 100 grams corn was mixed with 80 ml water at 100° C. for 8 mm. The water was drained off, and the corn was mixed with 80 ml of 1% NaOH at 100° C. for 8 mm. The sample was washed over a #6 and #150 mesh screen to separate and collect the pericarp.

(c) Open-Blender method. Water (500 ml) was preheated to 96° C. in a steam-jacked twin-screw ribbon blender (Keebler Engineering, Chicago) fitted with a loose plastic cover to minimize evaporation. Corn (2.5 kg) was added and cooked for 5 minutes with the steam valve open and the blender running. Various volumes of a 4%, 3% or 2.5% sodium hydroxide solution were added and the corn was cooked for another 4 minutes. The corn was then washed with water over a #6 mesh screen using a normal kitchen dish sprayer to remove and collect pericarp.

The separated pericarp was collected and weighed.

Results

The single-step method used 120 grams of NaOH per kg corn and produced an average of 127.5 (82.5-212) grams wet pericarp per 2.5 kg corn.

The two-step method used 8 grams of NaOH per kg corn and produced an average of 64 grams of pericarp per 2.5 kg corn.

The blender method consumed 4-5 grams NaOH per kg corn and produced 90 to 126 grams pericarp per 2.5 kg corn.

Conclusion

Both the two-step method and the blender method used much less sodium hydroxide than the single-step method, while still giving significant recovery of pericarp. The blender method gave comparable recovery of pericarp compared to the single-step method, while using less than 1/25th as much sodium hydroxide as the conventional method.

### Example 5

### Comparison of Blender Methods

Methods

(a) Standard Open-Blender Method. This is the blender method of Example 4.

(b) Low-Water Blender Method. Tap water (200 ml) was preheated to 96° C. in a preheated ribbon blender. Corn (2.5 kg) was added and mixed for 1 minute with the steam valve closed and the blender running. The corn was then transferred to a preheated vibrating-bed dryer. This shop-built unit consisted to two electric air heaters (Omegalux AHF14240, 2000 watts ea, Omega Engineering, Stamford, Conn.), a small blower (Dayton 4C440), and a stainless steel bed 8″×12″ at the base with a perforated stainless steel screen bottom and an air plenum below, along with associated ducts, controls, and instruments. The bed was mounted on springs and moved up and down by a crank arm (5/16″ total throw, about 540 strokes/minute) driven by a 1 hp variable-speed DC motor (Powertech) while hot air was blown through the corn. The steam valve on the blender was opened and the blender was reheated. The corn was shaken and heated until it reached a temperature of 98° C. (7 to 8 minutes). The corn was then returned to the blender, and a volume of a sodium hydroxide solution (various concentrations) was added and the corn was cooked for 4 minutes. The steam valve was then closed, 1 L of cold water was added, and the corn mixed for another 3 minutes. The corn was washed with water over a #6 and a #120 mesh screen to remove and collect pericarp. Corn was stained with methylene blue as in Example 1 after processing.

Results

The results are shown in Table 1.

TABLE 1

| | | | | | | Pericarp | |
|---|---|---|---|---|---|---|---|
| | | | Base | Base | Pericarp | dry | |
| | Water | Base | concentration | total | volume | weight | |
| Method | (ml) | (ml) | (%) | (g) | (m) | (g) | Results¹/notes |
| Standard | 500 | 250 | 4 | 10 | 1000 | 89.9 | 9c |
| Low | 200 | 250 | 4 | 10 | 1000 | 52.9 | 9c |
| Standard | 500 | 300 | 3 | 9 | 125 | 3.5 | 7 |
| Low | 200 | 300 | 3 | 9 | 300 | 11.2 | 9a |
| Standard | 500 | 300 | 3 | 9 | 250 | 17.5 | 9a |
| Low | 200 | 300 | 3 | 9 | 500 | 30.0 | 9b |
| Low | 200 | 267 | 3 | 8 | 475 | 29.0 | 9b |
| Standard | 500 | 280 | 2.5 | 7 | 400 | 17.5 | 8 |
| Low | 200 | 280 | 2.5 | 7 | 225 | 15.6 | 8 |
| Low | 200 | 233 | 3 | 7 | 225 | 18.7 | 8 |

¹Results:
8 - Pericarp loose but attached at tip cap
9a - less than 50% pericarp removal (dissolved or washed off)/aleurone intact
9b - 50 to 75% pericarp removal (dissolved or washed off)/aleurone intact
9c - 75 to 90% pericarp removal (dissolved or washed off)/aleurone intact
10 - greater than 90% pericarp removal (dissolved or washed off)/aleurone intact

The best yield of pericarp was provided by the standard blender method with 250 ml of 4% sodium hydroxide. The methods that gave the next three highest recoveries of pericarp, all of which gave 50-90% removal of pericarp in the washing step, were all low-water blender methods, using, in order, 250 ml 4% NaOH, 300 ml 3% NaOH, or 267 ml 3% NaOH.

Conclusion

The results show that both the standard two-step blender method and the low water two-step blender method give good removal of pericarp. Decreasing the water level in the corn after the initial water treatment appeared to offer a small advantage when less than optimal amounts of base were used.

### Example 6

### Pressurizable Mixer Procedure for Detaching Bran

A jacketed, variable-speed, single-ribbon mixer of about 3 ft³ capacity (Readco, York, Pa.) was fitted with a stainless steel lid and o-ring seal, permitting it to be pressurized to 15.psi. The lid was fitted with a pressure gauge, rupture disk, safety valve, a thermocouple projecting into the headspace, a 2″ ball valve with funnel for additions, and a ¼″ ball valve for manual pressure release. A drilled-pipe spray bar was fitted through the spray bar opening in the end of the mixer and connected through an L-pattern ball valve and check valves so that it could be used to supply steam directly into the headspace or spray streams of water or base solution onto the corn as it was mixed. This spray bar could also be turned to wash down the sides of the mixer. The bottom of the mixer had a 4″ ball valve to discharge product and a thermocouple port so fitted that the thermocouple could be inserted into the mass of product with the mixer stopped but still under pressure.

To prepare for use the jacket was connected to a 30 psi steam source. Steam was added to the jacket to preheat the empty mixer until a jacket pressure of 18 psi was reached. Steam was also supplied through the spray bar to preheat the internal parts and headplate, for 15 minutes.

Water (4.6 kg) was added to the empty, preheated mixer and heated to boiling with heat supplied through the jacket and mixing at 72 rpm. 25 kg corn was then added and mixed. When the headspace temperature reached 97° C., the pressure discharge valve was closed and heating was continued until the headspace temperature reached 101° C. 15 minutes after addition of the corn. At this point the corn temperature also read 101° C. Corn temperature was determined by inserting the bottom thermocouple into the mass of corn with the mixer stopped but under pressure.

Sodium hydroxide (105g) dissolved in 2.30 kg boiling water was transferred to a pressurizable stainless steel dispensing tank (Alloy Products Corp.), and transferred into the mixer through the spray bar by air pressure and applied to the corn with continuous mixing. Excess air was vented through the pressure release valve. Heating was continued with the valve closed and steam addition through the spray bar so that pressure built up. Mixing and steam addition (to both headspace and jacket) were stopped 8 minutes after the sodium hydroxide was added. At this point the corn temperature was 104° C.

Water (9.2 kg) at about 20° C. was then added through the spray bar with resumed mixing, the pressure release valve was opened to equalize pressures, and the mixture was agitated for 5 minutes. The product was then discharged from the mixer through the bottom valve with the aid of the agitator and a further addition of 9.6 kg water through the spray bar. The product at this point was a slurry of debranned kernels in a thick brown suspension of released pericarp.

The product slurry was transferred to a stainless steel hopper supplying a vibrating feeder (Eriez Magnetics) and applied at a steady rate to a 18″ SWECO gyratory screen with 6-mesh and 24 mesh sieves, such that the corn did not exceed ½″ depth on the screen. The corn was washed on the sieve by a spray of wash water (a total of 33 kg wash water was used) and the wash water was collected below the 24-mesh sieve and reused. A small stainless steel diverter bolted to the side next to the nozzles was employed to keep corn from bypassing the spray. The wash water was applied as a flat spray through two nozzles, angled about 15 degrees in the direction of motion of the corn. The nozzles were constructed by flattening one end of a piece of one inch diameter aluminum tubing to leave a discharge slot 2-3 mm wide. A plastic lid helped contain the splatter, and a stainless steel diverter was positioned to direct the washed corn to the discharge while letting the corn which missed the spray to recirculate. Detached pericarp passed through the 6-mesh sieve and was collected on the 24-mesh sieve below, from which it was discharged to a separate container. It was subsequently dewatered by passing it through the apparatus again without washing.

The product debranned corn (35.5 kg) had a temperature of 53° C., moisture content 42.2%, 9.4% protein dry basis, and 2.88% neutral detergent fiber dry basis, compared with 9.2% moisture, 9.04% protein (dry basis) and 4.54% neutral detergent fiber (dry basis) in the starting corn. The wet pericarp (4.66 kg) contained a total of 265 g dry matter. The recovered wash waters contained 1.8% dry matter for a total of 690 g.

### Example 7

### Adaptation of the Method to Corn That is More Difficult to Debran

A batch of corn that had a substantial portion (about ½) rounded, reddish kernels was treated by the methods described herein. This lot proved difficult to debran under conditions which had worked well with other lots of corn, but could be debranned readily with higher base usage. For instance, in the open mixer, 4.8 g NaOH/kg corn gave partial debranning, 189.1 g wet pericarp containing 15 g dry matter from 2.5 kg corn, while 5.76 g/kg gave 455 g wet pericarp containing 32.2 g dry matter. In the pressurizable mixer, 4 g NaOH/kg corn gave no visible bran removal, 5.25 g/kg gave 5.59 kg wet pericarp containing 302 g dry matter from 23 kg corn, while 5.6 g/kg gave 5.25 kg wet pericarp containing 464 g dry matter from 23 kg corn. The rounded, initially reddish kernels were the most difficult to debran, and were darkened by the procedure.

### Example 8

### Large Scale Debranning

To generate a large amount of recovered pericarp, four 30 kg debranning runs employing 4.8 g NaOH/kg corn essentially as in Example 6 were performed, except that the pericarp was not dewatered after collection. These runs generated a total of 33.7 kg of wet pericarp and 96 kg of wash, containing together 9.24 kg of combined bran dry matter. The runs gave consistent dry matter yield and good recovery as shown in Table 2, despite substantial variation in moisture content of the pericarp fraction. The wash was concentrated by ultrafiltration using a Scepter ceramic/stainless steel composite membrane module (Graver Technologies, Glasgow, Del.). This gave 31.31 kg permeate containing 0.34 kg solids, and the retentate was combined with the wet pericarp to give 91.55 kg wet combined bran.

TABLE 2

| | Dry matter content of fraction | | | Recovery | |
|---|---|---|---|---|---|
| | % weight to weight | | | % total dry inputs | |
| | Wet | | | | |
| Run | Pericarp | Wash | Debranned Corn | Combined Bran | Total |
| 1 | 6.3% | 4.8% | 57.6% | 5.8% | 99.6% |
| 2 | 8.1% | 4.6% | 57.2% | 6.1% | 98.1% |
| 3 | 9.8% | 5.1% | 58.3% | 6.4% | 103.4% |
| 4 | 11.6% | 5.1% | 58.5% | 6.3% | 99.8% |
| Average | 8.9% | 4.9% | 57.9% | 6.2% | 100.2% |
| RSD | 25.2% | 4.9% | 1.0% | 4.2% | 2.3% |

RSD = relative standard deviation

Taking all of the above results into account, but again not wishing to be bound by theory, preferred embodiments of the invention can be characterized in the following terms. In one embodiment, the method is applied to corn, the aqueous base comprises sodium hydroxide, and less than 5.5 grams of sodium hydroxide per kilogram of corn is consumed. In another embodiment, the grain is corn, the aqueous base comprises potassium hydroxide, and less than 6.5 grams of potassium hydroxide per kilogram of corn is consumed. In yet another embodiment, the grain is corn, less than eight grams of base per kilogram of corn is consumed, and the pericarp is detached from the corn without use of mechanical elements that directly contact the bran. Examples of such mechanical elements are brushes, abrasive screens, and abrasive pads. Similarly, in another embodiment of the invention, the grain is corn, less than eight grams of base per kilogram of corn is consumed, and the pericarp is detached from the corn by agitation with water or water spray having motive pressure less than one hundred twenty pounds per square inch (psi), if not even less than sixty psi. In another embodiment, the grain is corn, the aqueous base comprises sodium hydroxide, the sodium content of the grain is increased by no more than 0.05% by weight, and any rinsing after treatment with the aqueous base occurs for less than ten minutes. In a similar embodiment, the sodium content of the grain is increased by no more than 0.1 % by weight. In yet another similar embodiment, the grain is corn, the aqueous base comprises potassium hydroxide, potassium content of the grain is increased by no more than 0.15% by weight, and any rinsing after treatment with the aqueous base occurs for less than ten minutes. In yet another embodiment, the invention is a method of debranning grain using aqueous base in which pH of un-neutralized endosperm is not appreciably increased.

All references cited above are incorporated by reference.

1. A method for debranning grain comprising treating the grain with hot water, followed by treating the grain with an aqueous solution of a strong base; and detaching pericarp from the grain to yield debranned grain.

2. The method of claim 1, in which the treating the grain with water is at a temperature of at least about 70° C.

3. The method of claim 2, in which the treating the grain with water is at a temperature of at least about 85° C.

4. The method of claim 1, in which the aqueous solution of strong base contains less than about 0.5 mole equivalents of base per kg of grain.

5. The method of claim 4, in which the aqueous solution of strong base contains less than about 0.2 mole equivalents of base per kg of grain.

6. The method of claim 1, in which treating the grain with an aqueous solution of a strong base detaches the pericarp.

7. The method of claim 1, in which the detaching comprises adding water to the grain to form a grain-water mixture and agitating the grain-water mixture to detach the pericarp from the grain.

8. The method of claim 1, further comprising releasing the pericarp from the debranned grain.

9. The method of claim 8, in which the releasing comprises adding water to the grain to form a grain-water mixture and agitating the grain-water mixture to release the pericarp from the debranned grain.

10. The method of claim 8, further comprising separating the released pericarp from the debranned grain.

11. The method of claim 10, in which the separating comprises contacting the grain with a screen to separate the released pericarp from the debranned grain.

12. The method of claim 1, in which the grain is corn.

13. The method of claim 1, in which the grain is wheat, rice, oats, milo, sorghum, barley, or hulless barley.

14. The method of claim 1, in which the amount of the water used in treating the grain with water is 2% to 30% of the starting weight of the grain.

15. The method of claim 14, in which the amount of the water is 7% to 25% of the starting weight of the grain.

16. The method of claim 1, in which the treating the grain with water is for a time between about one minute and about thirty minutes.

17. The method of claim 1, in which the temperature of the mixture of the grain and the aqueous solution during the treating of the grain with an aqueous solution of a strong base is at least about 60° C.

18. The method of claim 17, in which the temperature of the mixture of the grain and the aqueous solution during the treating of the grain with an aqueous solution of a strong base is between about 90° C. and about 110° C.

19. The method of claim 1, in which the treating the grain with an aqueous solution of a strong base is for a time between about one minute and about thirty minutes.

20. The method of claim 1, in which the moisture content of the debranned grain is 35% to 50% by weight.

21. The method of claim 1, in which following treating the grain with water, the aqueous solution of a strong base is formed by adding a strong base to the water.

22. The method of claim 1, in which the pH of endosperm of the grain is not substantially increased by the aqueous solution of a strong base.

23. Debranned grain produced by the method of claim 1.

24. A method of producing ethanol from grain, comprising debranning the grain by the method of claim 1; hydrolyzing the debranned grain to sugars; and fermenting the sugars to provide ethanol.

25 The method of claim 1, in which the grain is corn and the aqueous base comprises sodium hydroxide, and in which less than 5.5 grams of sodium hydroxide per kilogram of corn is consumed.

26. The method of claim 1, in which the grain is corn and the aqueous base comprises potassium hydroxide, and in which less than 6.5 grams of potassium hydroxide per kilogram of corn is consumed.

27. The method of claim 1, in which the grain is corn, less than eight grams of base per kilogram of corn is consumed, and the pericarp is detached from the corn without use of mechanical elements that directly contact the bran.

28. The method of claim 27, in which the pericarp is detached and separated from the grain without use of brushes, abrasive screens, or abrasive pads.

29. The method of claim 1, in which the grain is corn and the aqueous base comprises sodium hydroxide, sodium content of the grain is increased by no more than 0.10% by weight, and any rinsing after treatment with the aqueous base occurs for less than ten minutes.

30. The method of claim 29, in which sodium content of the grain is increased by no more than 0.05% by weight.

31. The method of claim 1, in which the grain is corn and the aqueous base comprises potassium hydroxide, potassium content of the grain is increased by no more than 0.25% by weight, and any rinsing after treatment with the aqueous base occurs for less than ten minutes.

32. The method of claim 32, in which potassium content of the grain is increased by no more than 0.15% by weight.

33. A method of debranning grain using aqueous base in which pH of un-neutralized endosperm is not appreciably increased.

34. A method of chemically or enzymatically modifying a grain, comprising treating the grain with water to create a permeability barrier in the endosperm of the grain between a portion of the grain outside the permeability barrier and a portion of the grain inside the permeability barrier; and chemically or enzymatically modifying the portion of the grain outside the permeability barrier, without modifying the portion of the grain inside the permeability barrier.

35. The method of claim 34, in which the treating the grain with water is at a temperature of at least about 70° C.

36. The method of claim 35, in which the treating the grain with water is at a temperature of at least about 85° C.

37. The method of claim 34, in which the treating the grain with water is for a time between about one minute and about thirty minutes.

38. The method of claim 34, in which the grain is corn.

39. The method of claim 34, in which the grain is wheat, rice, oats, milo, sorghum, barley, or hulless barley.

40. The method of claim 34, comprising chemically modifying the portion of the grain outside the permeability barrier by treating the grain with base.

41. The method of claim 34, comprising enzymatically modifying the portion of the grain outside the permeability barrier.

42. The method of claim 41, in which the enzymatically modifying comprises treating the grain with a hydrolytic enzyme.
